(19) United States
(12) Patent Application Publication
(10) Pub. No.: US 2025/0237803 A1
(43) Pub. Date: Jul. 24, 2025

(54) DISPLAY BASED ON COLOR SELECTIVE DIFFRACTION GRATINGS

(71) Applicant: The Hong Kong University of Science and Technology, Hong Kong (CN)

(72) Inventor: Kristiaan Neyts, Hong Kong (CN)

(21) Appl. No.: 19/036,783

(22) Filed: Jan. 24, 2025

Related U.S. Application Data
(60) Provisional application No. 63/624,294, filed on Jan. 24, 2024.

(51) Int. Cl. F21V 8/00

(52) U.S. Cl. CPC G02B 6/005; G02B 6/0023

(57) ABSTRACT

A backlight for a liquid crystal display (LCD) includes: a waveguide configured to receive a collimated RGB beam; a plurality of color-selective diffractive gratings disposed on the waveguide, wherein each color-selective diffractive grating of the plurality of color-selective diffractive gratings is configured to out-couple a beam of a single color from the waveguide; and a beam in-coupler configured to adjust an angle of incidence into the waveguide with respect to the collimated RGB beam.

### CROSS-REFERENCE TO RELATED APPLICATIONS

This application claims priority to U.S. Provisional Patent Application No. 63/624,294, filed on Jan. 24, 2024, which is hereby incorporated by reference in its entirety.

### TECHNICAL FIELD

Embodiments of this application relate to the field of liquid crystal displays (LCDs). In particular, embodiments of this application relate to LCDs with color-selective diffraction grating to display 3D images without using specially designed 3D glasses.

### BACKGROUND

Liquid crystal displays (LCDs) have high quality, but their efficiency is not high because of losses in the polarizers and color filters, and thus a lot of light does not reach the eyes of the viewers. Conventional LCDs use backlights which emit red, green and blue light homogeneously over the entire area and in all directions. The LC pixels modulate the polarization state of the light. A polarizer is used to select one polarization, and a color filter is used to specify the color that has to be modulated. In each component there is a large absorption. The LC pixel should be able to modulate light with different angles of incidence in the same way, because the viewer should be able to see the image on the display from many different angles.

There is an interest to show 3D images on a display without a viewer needing to use specially designed glasses to view the 3D images. Some conventional approaches for 3D displays have been developed, but they each have various drawbacks.

In a first conventional approach, the LCD display uses a parallel beam of light from a backlight. The light through the pixels of the display have a small angle of incidence which enhances the contrast and transmission of the display. For a standard display, a scattering layer can be disposed at the output side of the display, so that light can be emitted in all directions. In this approach there is a challenge in creating a backlight that is highly collimated, which requires improved additional optical components.

In a second conventional approach, LCDs without color filters are provided, based on backlights with color sequential illumination. In this case, the color of the backlight has a red/green/blue sequence. However, the LC modulating pixels must switch between three different gray scales for red, green and blue respectively. And for LC modes, even if smectic ferro-electric materials are utilized to realize fast switching, switching within a few millisecond (ms) may remain a challenge without disturbing the audience experience.

In a third conventional approach, waveguide-based LCDs have also been developed for AR/VR applications. Waveguides with in-coupling and outcoupling of light have been investigated for use in augmented reality and virtual reality. Diffrative gratings are used to couple light from a microdisplay into a waveguide, and another grating is used to outcouple the light from the waveguide to the eye box of the observer—i.e., the light is modulated before entering the waveguide. Three gratings are used on top of each other for the colors red, green and blue. The angle of the light after outcoupling is linked to the angle of the light before incoupling.

In a fourth conventional approach, LCDs for 3D imaging based on cylindrical lenticulars that project the light passing through neighboring pixels in different directions have also been developed. Such a multiview display can, for example, show eight different images in different directions in space, with a resolution that is 8 times less. However, the lenticulars, which are fixed on the display, can lead to very disturbing views when the eyes of an observer transit from one viewing zone to the next viewing zone. The 3D effect is only visible to the observer when both eyes are completely in a zone without overlap illumination.

In a fifth conventional approach, in and outcoupling gratings based on chiral liquid crystals have been tried. In these applications, the outcoupling is realized by a grating. Typically, these gratings have large dimensions and are not aligned with pixels of a display.

### SUMMARY

In an exemplary embodiment, the present disclosure provides a backlight for a liquid crystal display (LCD). The backlight includes: a waveguide configured to receive a collimated RGB beam; a plurality of color-selective diffractive gratings disposed on the waveguide, wherein each color-selective diffractive grating of the plurality of color-selective diffractive gratings is configured to out-couple a beam of a single color from the waveguide; and a beam in-coupler configured to adjust an angle of incidence into the waveguide with respect to the collimated RGB beam.

In a further exemplary embodiment, the beam in-coupler comprises a quarter-wave plate, a rotatable mirror, and a lens.

In a further exemplary embodiment, the beam in-coupler further comprises a quarter-wave plate, a switchable half-wave plate, and a grating.

In a further exemplary embodiment, the plurality of color-selective diffractive gratings includes a first set of color-selective diffractive gratings configured to direct out-coupled light to a first eye of the viewer and a second set of color-selective diffractive gratings configured to direct out-coupled light to a second eye of the viewer.

In a further exemplary embodiment, the waveguide comprises: a local waveguide portion; and a long-distance waveguide portion configured to receive the collimated RGB beam and output respective portions of the collimated RGB beam to respective injection sites on the local waveguide portion.

In another exemplary embodiment, the present disclosure provides a system for controlling output of a liquid crystal display (LCD). The system includes: a camera configured to obtain eye position information of a viewer of the LCD; the LCD, wherein the LCD comprises a backlight, and wherein the backlight comprises: a waveguide configured to receive a collimated RGB beam; a plurality of color-selective diffractive gratings disposed on the waveguide, wherein each color-selective diffractive grating of the plurality of color-selective diffractive gratings is configured to out-couple a beam of a single color from the waveguide; and a beam in-coupler configured to adjust an angle of incidence into the waveguide with respect to the collimated RGB beam; and a processor configured to use the eye position information of the viewer obtained by the camera to control the beam in-coupler.

In a further exemplary embodiment, the beam in-coupler comprises a quarter-wave plate, a rotatable mirror, and a lens.

In a further exemplary embodiment, the beam in-coupler further comprises a quarter-wave plate, a switchable half-wave plate, and a grating.

In a further exemplary embodiment, the LCD further comprises: a quarter wave plate configured to convert circularly polarized light to linearly polarized light; a first polarizer; a liquid crystal layer comprising a plurality of pixels; and a second polarizer.

In a further exemplary embodiment, each of the plurality of pixels comprises a plurality of subpixels, wherein each subpixel corresponds to a single color and is aligned to a respective corresponding color-selective diffractive grating of the backlight.

In a further exemplary embodiment, the plurality of color-selective diffractive gratings includes a first set of color-selective diffractive gratings configured to direct out-coupled light to a first eye of the viewer and a second set of color-selective diffractive gratings configured to direct out-coupled light to a second eye of the viewer.

In a further exemplary embodiment, the waveguide comprises: a local waveguide portion; and a long-distance waveguide portion configured to receive the collimated RGB beam and output respective portions of the collimated RGB beam to respective injection sites on the local waveguide portion.

In yet another exemplary embodiment, the present disclosure provides an out-coupling structure. The out-coupling structure includes: a plurality of color-selective diffractive gratings disposed on a waveguide, including: a first color-selective diffractive grating corresponding to a first color; a second color-selective diffractive grating corresponding to a second color; a third color-selective diffractive grating corresponding to a third color; a fourth color-selective diffractive grating corresponding to the first color; a fifth color-selective diffractive grating corresponding to the second color; and a sixth color-selective diffractive grating corresponding to the third color. The first, second and third color-selective diffractive gratings are configured to direct out-coupled light to a first eye of the viewer. The fourth, fifth and sixth color-selective diffractive gratings are configured to direct out-coupled light to a second eye of the viewer.

In a further exemplary embodiment, each of the plurality of color-selective diffractive gratings comprises a chiral liquid crystal (CLC) layer having a tilted helical structure.

In a further exemplary embodiment, the CLC layers of the first, second, third, fourth, fifth and sixth color-selective diffractive gratings have a different respective lateral period Λ in the plane of the waveguide.

In a further exemplary embodiment, the lateral period Λ for a respective color-selective diffractive grating includes a first period Λx corresponding to an x-direction and a second period Λy corresponding to a y-direction.

In a further exemplary embodiment, the plurality of color-selective diffractive gratings are arranged in a plurality of columns; and the out-coupling structure further comprises a plurality of light redirection gratings configured to receive an incident RGB beam and redirect portions of the incident RGB beam towards respective columns of the plurality of columns.

In a further exemplary embodiment, a respective light redirection grating closer to a point of incidence of the RGB beam is smaller than a second respective light redirection grating farther from the point of incidence of the RGB beam.

### BRIEF DESCRIPTION OF DRAWINGS

FIG. 1 shows a block diagram of an example system according to an embodiment of this application;

FIG. 2 shows a waveguide plate with collimated beam entering from the left and out-coupling through diffraction gratings on top of the waveguide plate according to an embodiment of this application;

FIG. 3 shows an example of the working principles of a diffraction grating according to an embodiment of this application;

FIG. 4 shows how diffraction gratings of two different groups send light towards the two eyes according to an embodiment of this application;

FIG. 5 shows a front view of a display with a 2D array of diffraction gratings according to an embodiment of this application;

FIGS. 6-7 show examples of manners of coupling a collimated beam with a variable angle of incidence into a waveguide;

FIG. 8 shows an example of a distribution of light over a long-distance waveguide and a local waveguide; and

FIG. 9 shows a 3D display in which eye tracking is realized with adjusting the direction of the incident collimated beam in the waveguide according to an embodiment of this application.

### DETAILED DESCRIPTION

Conventional color LCDs typically use a white light source, and each pixel is configured to modulate red, green or blue light based on color filters. In embodiments of the present disclosure, the color filters are replaced with diffrative gratings, which couple out red, green or blue light from the backlight in which light is waveguided.

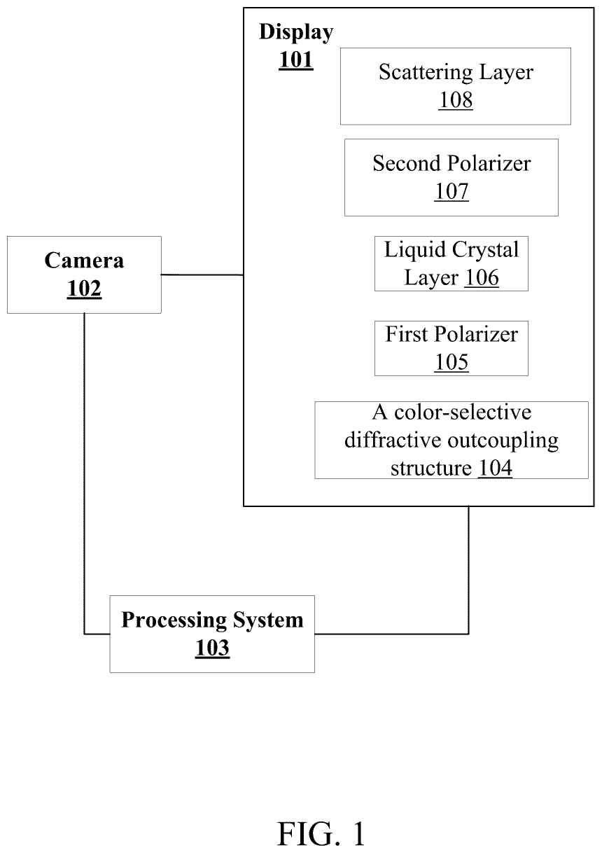

FIG. 1 shows a block diagram of an example system according to an embodiment of this application. The display 101 has a color-selective diffractive out-coupling structure 104, a first polarizer 105, a liquid crystal layer 106, and a second polarizer 107. The color-selective diffractive out-coupling structure 104 is configured to separate collimated red, green and blue (RGB) light into R, G and B beams directed to a viewer's eyes.

The display 101 uses a backlight with highly collimated light and red, green and blue light sources with narrow wavelength ranges. The light passing through each pixel is close to a plane wave. For normal display operation, scattering layer 108 may be placed after a modulating panel, but it will be appreciated that other applications are also possible. The scattering layer 108 may be disposed on the front of the display 101, so as to emit modulated RGB lighting all directions.

Light can be directed, for example, towards the left or right eye of a viewer. The propagation director of the collimated light in the backlight may be tuned to direct the light of the display towards the eyes of the viewer, when eye tracking is available. Half of the pixels may be used to direct the light to the right eye and half of the pixels may be used to direct the light to the left eye. A camera 102 may be connected to the display 101 directly or indirectly (e.g., through a processing system 103), to detect eye position(s) of a viewer, so as to enable the display 101 to adjust direction(s) of the modulated RGB light based on the eye position(s) of the viewer.

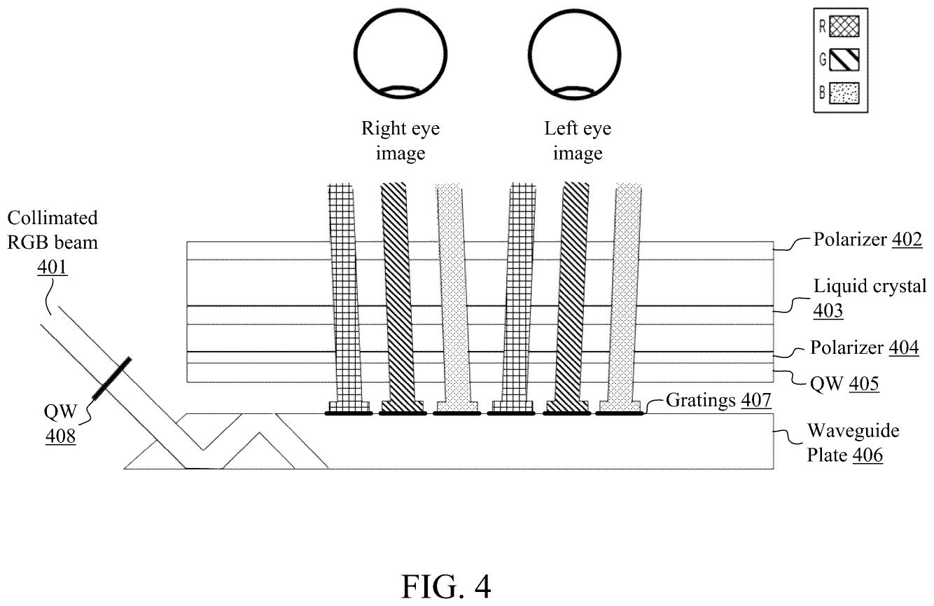

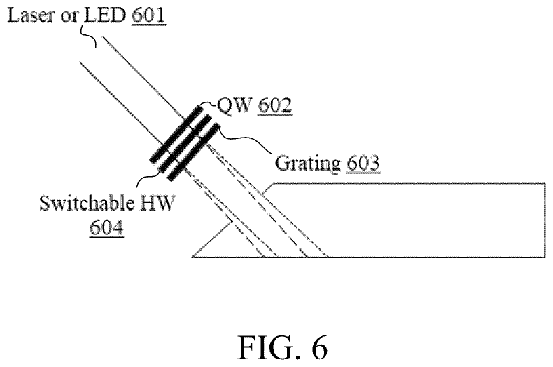

In embodiments of the present disclosure, the absorbing color filters for each pixel of conventional LCDs are replaced by the color-selective diffraction grating 104 (see also grating 407 in FIG. 4 and grating 609 in FIG. 6, as will be discussed below). Collimated red, green and blue light is coupled into a planar waveguide structure. Waveguiding occurs due to total internal reflection at the top and bottom of the planar waveguide. Waveguiding can be interrupted by the color-selective diffraction grating 104 on top of the waveguide, when this grating couples the light out towards the vertical direction.

The RGB color-selective waveguide gratings are aligned with respective RGB pixels of the display 101. The polarization state of the outcoupled light is adjusted to maximize the transmission through a first polarizer 105. The polarization state is modulated by the pixels in the liquid crystal layer 106, depending on the applied voltage. The modulated light reaches the second polarizer 107 where part of the light is absorbed. After that, the light travels towards the viewer.

The display 101 may thus be a 3D display system which allows a viewer to view 3D images without the need for glasses. It will be appreciated that the processing system 103 may include one or more processors internal to display 101 and/or one or more processors external to display 101. The processing system 103 may be configured to control camera 102 and/or obtain eye position data from the camera 102, and use the eye position data in controlling the output of the display 101. It will also be appreciated that camera 102 may be part of display 101 or may be a separate device that is external relative to display 101.

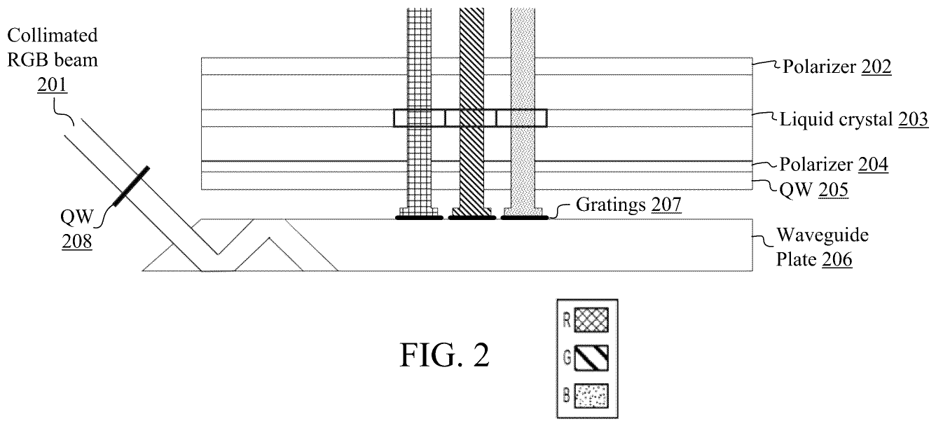

FIG. 2 shows a waveguide plate 206 with collimated beam entering from the left and out-coupling through diffraction gratings 207 on top of the waveguide plate 206 according to an embodiment of this application. Collimated RGB beam 201 passes through quarter wave (QW) plate 208, enters the waveguide plate 206, and outcouples through diffraction gratings 207 to provide backlight illumination. The individual R, G and B beams travel through QW 205 to create linearly polarized light, first polarizer 204, liquid crystal layer 203, and second polarizer 202 to provide the display output. Glass plates are respectively disposed between the first polarizer 204 and the liquid crystal layer 203, and between the liquid crystal layer 203 and the second polarizer 202.

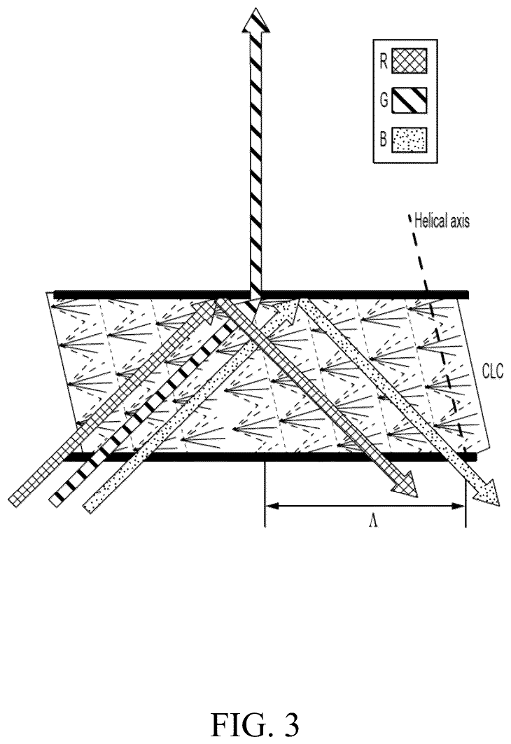

FIG. 3 shows the internal structure of a diffraction grating for the waveguide plate 206 of FIG. 2. The diffraction grating is disposed on top of the waveguide plate and comprises a chiral liquid crystal (CLC) layer with tilted helical structure, where only one wavelength is selected and the light leaves the waveguide plate 206 perpendicularly, according to an embodiment of this application. Chiral liquid crystal has a periodic structure of polymerized chiral liquid crystal, with the optical properties varying along the helical axis, shown in FIG. 3, with period p. The chiral liquid crystal can diffract light with a certain wavelength range: e.g., red, green or blue light. The lateral period Λ of the CLC layer in the plane of the grating determines the wavelength of light (e.g., 400 nm to 700 nm) that will be diffracted and determines the angle over which the light is diffracted. The CLC material for each subpixel in the display has a respective lateral period Λ, to diffract one of the three colors R, G, and B. Each subpixel is aligned with a diffraction grating with a different value, to couple the incoming light into a particular direction. For example, when the incoming beam is in a reference angle, then a first group of color-selective diffractive gratings may send the light 3 cm to the left of the perpendicular bisector (right eye of the viewer) and a second group of color-selective diffractive gratings send the light 3 cm to the right for the left eye, assuming the distance between the two eyes is about 6 cm.

The lateral period Λ of the CLC layer for each respective color-selective diffraction grating has a period Λx for the x-direction and a period Λy for the y-direction, and the periods Λx and Λy for each respective color-selective diffraction grating is based on several parameters: the position of the respective color-selective diffraction grating in the array of gratings, whether the respective color-selective diffractive grating corresponds to a left eye or a right eye of the viewer, and which color/wavelength(s) the respective color-selective diffractive grating is to diffract.

FIG. 4 shows how diffraction gratings of two different groups send light towards the two eyes of a viewer according to an embodiment of this application. Collimated RGB beam 401 passes through QW 408 and a color-selective diffractive out-coupling structure (e.g., element 104 in FIG. 1), which contains a plurality of color-selective diffractive gratings 407, QW 405, first polarizer 404, liquid crystal layer 403, and second polarizer 402. The plurality of color-selective diffractive gratings 407 are configured to diffract the modulated RGB light towards the right eye of a viewer via the first group of color-selective diffractive gratings, and to diffract the modulated RGB light towards the left eye of the viewer via the second group of the color-selective diffractive gratings. The light in the waveguide plate 406 should be parallel with a limited deviation angle, to ensure that the light only arrives at one eye, without leakage towards the other eye. For example, if a distance between the viewer and the display is 60 cm, the distance between the two eyes is about 6 cm, and the limited deviation angle should be below 6 degrees, i.e., arctan(6/60).

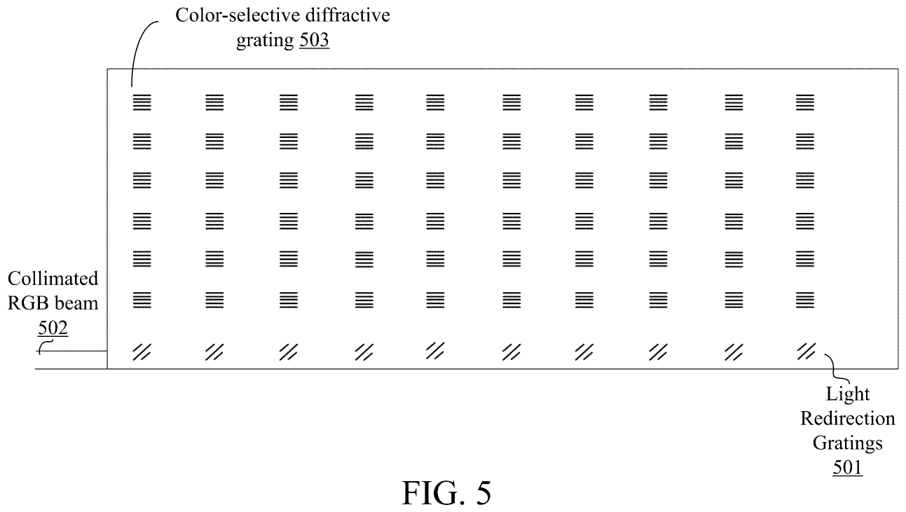

FIG. 5 shows a front view of a display with a 2D array of diffraction gratings according to an embodiment of this application. On the bottom, diffractive gratings 501 are shown that redirect the light 502, while remaining within the waveguide according to an embodiment of this application. The color-selective diffractive out-coupling structure (e.g., element 104 of FIG. 1) comprises a plurality of color-selective diffractive gratings 503, and each color-selective diffractive grating 503 is aligned with a particular subpixel of the display. The diffraction gratings that couple light out of the waveguide can be separated in two groups: the first group diffracts light towards the right eye of the viewer, and the second group diffracts light towards the left eye of the viewer. The diffracted beams for each group converge at a certain distance from the display (e.g., corresponding to a regular viewing distance). The two convergence points have a separation of about 60 mm (e.g., corresponding to a typical interpupil distance). That means that the diffraction grating in the middle of the display should have a different period Λ than the diffraction grating at the side of the display.

The distance between the waveguide plate and the subpixels of the LC is small (e.g., less than 100 μm) to ensure that the light from the grating passes only to the area of the subpixel for which it is aligned. The airgap and the glass substrate should be thin, so that a beam that is coupled out from the grating can be steered in the direction of the eye over different emission angles and still pass through the LC subpixel to which it is aligned.

In the example of FIG. 5, the collimated RGB beam 502 enters the waveguide from the left, and the light redirection gratings 501 increase in size from left to right such that each light redirection grating 501 redirects a substantially similar amount of light towards a respective column of color-selective diffractive gratings 503. In other words, it will be appreciated that the RGB beam has the most intensity at the point of incidence on the left, a small fraction is redirected to the first column of color-selective diffractive gratings 503 from the left by the first light redirection gratin 501 on the left, such that the collimated RGB beam which reaches the second light redirection grating 501 from the left has less light. Thus, the second light redirection grating 501 from the left is larger to redirect a relatively larger fraction of the relatively smaller amount of light, such that the amount of light redirected by the second light redirection grating 501 is similar to the amount of light redirected by the first light redirection grating 501.

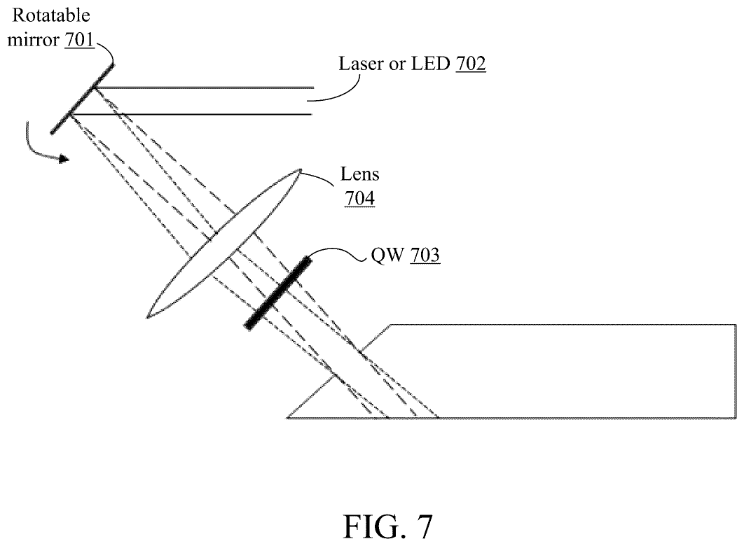

FIGS. 6-7 show examples of manners of coupling a collimated beam with a variable angle of incidence into a waveguide.

In FIG. 6, the steering of the angle of incidence of the collimated beam 601 that enters the waveguide is performed with a switchable half wave (HW) plate 604 and a grating 603. Grating 603 may be an LC Pancharatnam Berry grating diffracts Right and Left Handed Circularly Polarized light (RHCP and LHCP) in different directions with high efficiency. RHCP light can be obtained by using a quarter wave (QW) plate 602 in front of the linearly polarized laser beam. By switching the polarization state of the incoming beam with a switchable half wave plate (HW) 604 from RHCP to LHCP, the grating can steer the light in different directions. Multiple HW plates and gratings can be used to steer the light in multiple directions. When the angle of the collimated beam 201 is modified, then the light will reach the diffraction grating 207 with a different angle of incidence and after diffraction, and also a different emission angle will be achieved. This can be used to adjust the light of the display towards the eyes of the viewer.

In FIG. 7, the steering of the angle of incidence of the collimated beam 702 that enters the waveguide is performed with a rotatable mirror 701. The rotatable mirror reflects the incident collimated beam in different directions, depending on the orientation of the mirror—i.e., by rotating the mirror 701 located at the incoupling side, the emission angle can be continuously adjusted. Element 704 is a convex lens that images the spot where the collimated beam 702 reaches the mirror 701 onto the entrance face of the waveguide, in order to achieve an optical system with high efficiency. The collimated beam 702 may also pass through a QW plate 703. The backlight for a display device is generated after the RGB light travels through the waveguide, the rotatable mirror, and the color-selective diffractive gratings before reaching the first polarizer.

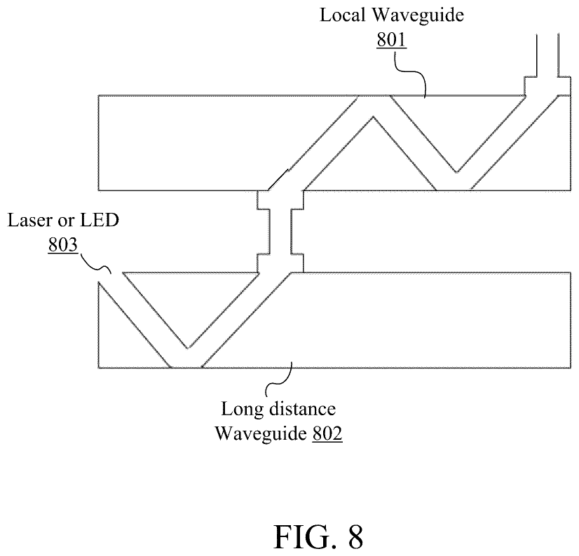

FIG. 8 shows an example of a distribution of light over a long-distance waveguide 802 and a local waveguide 801 according to an alternate embodiment in which the waveguide has two waveguide portions. In order to distribute the light incident from the side over a large distance, the outcoupling may be realized in two steps. In the long-distance waveguide 802, laser or LED RGB light 803 is transported over a long distance (with few outcoupling structures), and in the local waveguide 801, there is local waveguiding. When a single waveguide plate is used, the light has to travel over the entire width of the display to reach pixels at the right side. This means that the outcoupling gratings at the left side of the display should be very small (e.g., on the order of 5 μm by 5 μm), so that only a small fraction of the light is outcoupled (e.g., on the order of 1% or 0.1%), while most of the light is continuously waveguided, with the size of the gratings becoming larger towards the right side of the display. This issue can be solved by realizing multiple injection sections of light in the local waveguide plate 801, from the long distance waveguide plate 802. It will be appreciated that, in this alternate embodiment, light can be transported over a relatively small distance in the local waveguide 801, and it provides a relatively easy manner of ensuring a homogenous distribution of light over the entire width of the backlight.

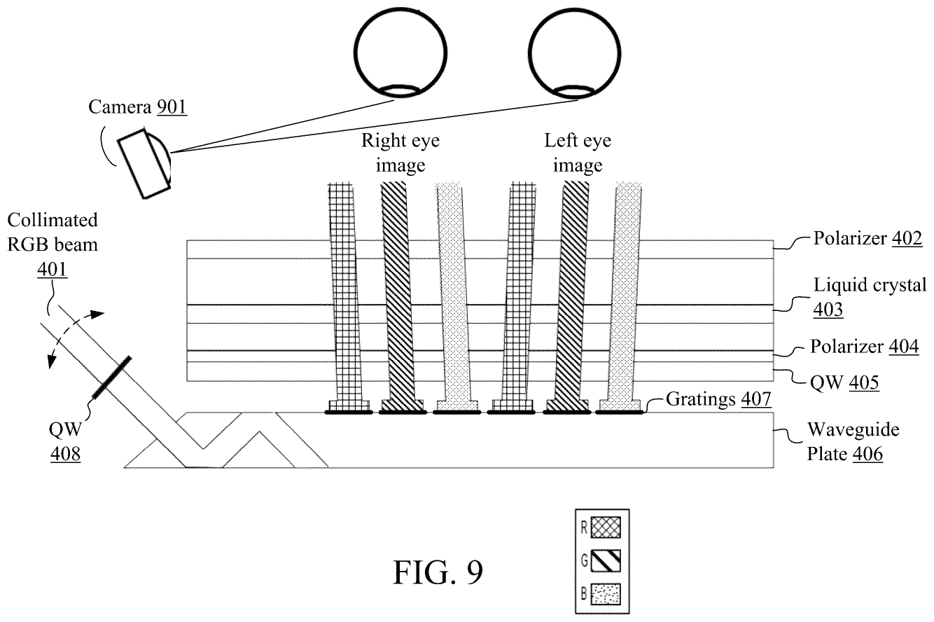

FIG. 9 shows a 3D display in which eye tracking is realized with adjusting the direction of the incident collimated beam in the waveguide according to an embodiment of this application. As discussed above with respect to FIG. 1, an eye tracking system that measures the position of a viewer's eyes may be utilized, and the eye positions can be used to steer the angle of incidence of the collimated beam that enters the waveguide. In this way, the two focal points of the groups of diffraction gratings can be adjusted to follow the position of the eye.

FIG. 9 shows a camera 901 which detects the eyes movement of a viewer. The camera 901 is connected to a processing system (e.g., element 103 of FIG. 1), and the processing system may utilize eye position information from the camera 901 to adjust focal points of the first and second groups of the color-selective diffractive gratings in accordance with the position of the right and left eyes of the viewer. According to FIG. 9, the gratings are different for every subpixel R, G, and B and for pixels intended for the left and right eyes. The deviation angle in the horizontal plane between the middle of the two eyes and the perpendicular bisector of the display can be estimated. Based on the estimated deviation angle, the incident beam in the waveguide is rotated over approximately the same angle, before entering the waveguide, to steer the light to the two eyes.

It will be appreciated that the figures herein are provided for illustration purposes and are not drawn to scale. For example, it would be understood that a viewer's eyes are much further away than the distance between neighboring color-selective diffractive gratings. Thus, on the scale of looking at the pixels, the R, G and B beams output from the color-selective diffractive gratings are nearly parallel, but taking a step back, the R, G and B beams corresponding to a respective pixel for a particular grating may not be entirely collimated (e.g., there may be some beam expansion), and are directed towards one of the viewer's eyes (based on the direction of the incoupling beam).

With respect to the incoupling RGB beam, it will be appreciated that the incoupling RGB includes collimated RGB light containing RGB beams that are parallel at the point of incidence into the waveguide, and the entire waveguide is filled with the RGB light that is reflected up and down. Light is outcoupled where a grating of a corresponding color is present.

It will further be appreciated that a set of R, G and B color-selective diffractive gratings may be considered as a single pixel which includes R, G and B sub-pixels. Each subpixel corresponds to a respective color-selective diffractive grating and a respective color.

It will be appreciated that exemplary embodiments of the present application provide various advantages over conventional LCD systems. For example, it has been demonstrated in exemplary implementations that an energy reduction of more than a factor 10 can be achieved relative to conventional LCDs (due to 2× more light passing through the first polarizer, 3× more light passing through via the color selection procedure, and light being only directed towards the eyes of the viewer without wasting light sent in other directions). It will further be appreciated that exemplary embodiments of the present application are able to adjust the direction of the in-coupled collimated beam, either continuously by the rotating mirror or by a set of diffraction gratings so as to achieve 3D viewing with continuous variation and without fixed transition zones (as in the case of lenticular multi-view systems).

It will be appreciated that the execution of the various machine-implemented processes and steps described herein may occur via the execution, by one or more respective processors, of processor-executable instructions stored on one or more tangible, non-transitory computer-readable mediums (such as random access memory (RAM), read-only memory (ROM), programmable read-only memory (PROM), and/or another electronic memory mechanism). Thus, for example, operations performed by various components as discussed herein may be carried out according to instructions stored on and/or applications installed on one or more respective computing devices.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A backlight for a liquid crystal display (LCD), comprising:
a waveguide configured to receive a collimated RGB beam;
a plurality of color-selective diffractive gratings disposed on the waveguide, wherein each color-selective diffractive grating of the plurality of color-selective diffractive gratings is configured to out-couple a beam of a single color from the waveguide; and
a beam in-coupler configured to adjust an angle of incidence into the waveguide with respect to the collimated RGB beam.

2. The backlight according to claim 1, wherein the beam in-coupler comprises a quarter-wave plate, a rotatable mirror, and a lens.

3. The backlight according to claim 1, wherein the beam in-coupler further comprises a quarter-wave plate, a switchable half-wave plate, and a grating.

4. The backlight according to claim 1, wherein the plurality of color-selective diffractive gratings includes a first set of color-selective diffractive gratings configured to direct out-coupled light to a first eye of the viewer and a second set of color-selective diffractive gratings configured to direct out-coupled light to a second eye of the viewer.

5. The backlight according to claim 1, wherein the waveguide comprises:
a local waveguide portion; and
a long-distance waveguide portion configured to receive the collimated RGB beam and output respective portions of the collimated RGB beam to respective injection sites on the local waveguide portion.

6. A system for controlling output of a liquid crystal display (LCD), comprising:
a camera configured to obtain eye position information of a viewer of the LCD;
the LCD, wherein the LCD comprises a backlight, and wherein the backlight comprises:
a waveguide configured to receive a collimated RGB beam;
a plurality of color-selective diffractive gratings disposed on the waveguide, wherein each color-selective diffractive grating of the plurality of color-selective diffractive gratings is configured to out-couple a beam of a single color from the waveguide; and
a beam in-coupler configured to adjust an angle of incidence into the waveguide with respect to the collimated RGB beam; and
a processor configured to use the eye position information of the viewer obtained by the camera to control the beam in-coupler.

7. The system according to claim 6, wherein the beam in-coupler comprises a quarter-wave plate, a rotatable mirror, and a lens.

8. The system according to claim 6, wherein the beam in-coupler further comprises a quarter-wave plate, a switchable half-wave plate, and a grating.

9. The system according to claim 6, wherein the LCD further comprises:
a quarter wave plate configured to convert circularly polarized light to linearly polarized light;
a first polarizer;
a liquid crystal layer comprising a plurality of pixels; and
a second polarizer.

10. The system according to claim 9, wherein each of the plurality of pixels comprises a plurality of subpixels, wherein each subpixel corresponds to a single color and is aligned to a respective corresponding color-selective diffractive grating of the backlight.

11. The system according to claim 6, wherein the plurality of color-selective diffractive gratings includes a first set of color-selective diffractive gratings configured to direct out-coupled light to a first eye of the viewer and a second set of color-selective diffractive gratings configured to direct out-coupled light to a second eye of the viewer.

12. The system according to claim 6, wherein the waveguide comprises:
a local waveguide portion; and
a long-distance waveguide portion configured to receive the collimated RGB beam and output respective portions of the collimated RGB beam to respective injection sites on the local waveguide portion.

13. An out-coupling structure, comprising:
a plurality of color-selective diffractive gratings disposed on a waveguide, including:
a first color-selective diffractive grating corresponding to a first color;
a second color-selective diffractive grating corresponding to a second color;
a third color-selective diffractive grating corresponding to a third color;
a fourth color-selective diffractive grating corresponding to the first color;
a fifth color-selective diffractive grating corresponding to the second color; and
a sixth color-selective diffractive grating corresponding to the third color;
wherein the first, second and third color-selective diffractive gratings are configured to direct out-coupled light to a first eye of the viewer;
wherein the fourth, fifth and sixth color-selective diffractive gratings are configured to direct out-coupled light to a second eye of the viewer.

14. The out-coupling structure according to claim 13, wherein each of the plurality of color-selective diffractive gratings comprises a chiral liquid crystal (CLC) layer having a tilted helical structure.

15. The out-coupling structure according to claim 14, wherein the CLC layers of the first, second, third, fourth, fifth and sixth color-selective diffractive gratings have a different respective lateral period Λ in the plane of the waveguide.

16. The out-coupling structure according to claim 15, wherein the lateral period Λ for a respective color-selective diffractive grating includes a first period Λx corresponding to an x-direction and a second period Λy corresponding to a y-direction.

17. The out-coupling structure according to claim 13, wherein the plurality of color-selective diffractive gratings are arranged in a plurality of columns; and
wherein the out-coupling structure further comprises a plurality of light redirection gratings configured to receive an incident RGB beam and redirect portions of the incident RGB beam towards respective columns of the plurality of columns.

18. The out-coupling structure according to claim 17, wherein a respective light redirection grating closer to a point of incidence of the RGB beam is smaller than a second respective light redirection grating farther from the point of incidence of the RGB beam.
